(19) United States
(12) Patent Application Publication
(10) Pub. No.: US 2025/0023930 A1
(43) Pub. Date: Jan. 16, 2025

(54) ARTIFICIAL INTELLIGENCE (AI)-BASED DOCUMENT RETRIEVAL DURING A VIRTUAL MEETING

(71) Applicant: Google LLC, Mountain View, CA (US)

(72) Inventor: Dongeek Shin, San Jose, CA (US)

(21) Appl. No.: 18/352,897

(22) Filed: Jul. 14, 2023

(51) Int. Cl. H04L 65/402

(52) U.S. Cl. CPC H04L 65/402

(57) ABSTRACT

Methods and systems for artificial intelligence (AI)-based document retrieval during a virtual meeting are provided herein. Discussion data based on multi-media stream(s) provided by client devices of participants of a virtual meeting is obtained. A determination is made of whether the discussion data corresponds to an information access query. In response to a determination that the discussion data corresponds to the information access query, the discussion data is provided as input to an AI model trained to identify one or more electronic documents including content that is relevant to given discussion data. An electronic document associated with at least one of the participants including content that is relevant to the given discussion data is identified based on output(s) of the AI model. At least a portion of the content of the electronic document is provided for presentation via a user interface (UI) at each client device associated with the participants.

### TECHNICAL FIELD

Aspects and implementations of the present disclosure relate to artificial intelligence (AI)-based document retrieval during a virtual meeting.

### BACKGROUND

A platform can enable users to connect with other users through a video-based or audio-based virtual meeting (e.g., a conference call). The platform can provide tools that allow multiple client devices to connect over a network and share each other's audio data (e.g., a voice of a user recorded via a microphone of a client device) and/or video data (e.g., a video captured by a camera of a client device, etc.) for efficient communication. In some instances, a platform can also enable a user to share video captured from a screen image of a client device. For example, a platform can enable a user that is accessing an electronic document (e.g., a word processing document, a slide presentation document, etc.) via a client device to share video captured from the screen image of the client device with other users to allow the other users to access the electronic document during the virtual meeting. Such feature is sometimes referred to as screen sharing. In some instances, a user may decide to share an electronic document with the other users during the virtual meeting (e.g., based on a discussion with the other users during the virtual meeting). It can take the user a significant amount of time to locate the appropriate electronic document for sharing, which can impact a flow of the discussion during the virtual meeting.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a method is disclosed for artificial intelligence (AI)-based document retrieval during a virtual meeting. The method includes obtaining, during a virtual meeting, discussion data based on one or more multi-media streams provided by one or more client devices of one or more participants of the virtual meeting. The method further includes determining whether the discussion data correspond to an information access query by the one or more participants. The method further includes responsive to determining that the discussion data correspond to the information access query, providing the discussion data as input to an artificial intelligence (AI) model. The AI model is trained to identify, from a data store including electronic documents associated with users of a platform, one or more electronic documents that include content that is relevant to given discussion data. The method further includes identifying, based on one or more outputs of the AI model, an electronic document associated with at least one of the participants that includes content that is relevant to the discussion data. The method further includes providing, during the virtual meeting, at least a portion of the content of the electronic document for presentation via a user interface (UI) at each client device of the one or more client devices.

In some implementations, the method further includes responsive to determining that the discussion data do not correspond to the information access query, determining that a time criterion associated with retraining the AI model is satisfied. The method further includes providing the discussion data for retraining the AI model. Determining that the time criterion associated with retraining the AI model is satisfied includes determining that an amount of time between a prior time period during which data was given to retrain the AI model and a current time period exceeds a threshold amount of time.

In some implementations, the method further includes extracting the information access query from the discussion data. The method further includes generating an AI model prompt based on the extracted information access query and an identifier associated with the one or more participants that provided the at least one of the one or more phrases, where the AI model prompt has a predefined prompt format. The method further includes providing the generated AI model prompt as input to the AI intelligence model.

In some implementations, determining whether the discussion data correspond to the information access query by the one or more participants includes providing the discussion data as input to an additional AI model. The additional AI model is trained to predict, based on given input discussion data, whether phrases indicated by the given discussion data correspond to one or more information sharing queries by a participant of the virtual meeting. The method further includes obtaining one or more outputs of the additional AI model, wherein the one or more outputs include a level of confidence that the discussion data corresponds to the information access query. The method further includes determining whether the level of confidence satisfies a level of confidence criterion.

In some implementations, the discussion data includes at least one of audio data comprising one or more audio signals collected by the one or more client devices or transcription data comprising a textual transcription of the one or more audio signals.

In some implementations, the AI model is a large language model.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram illustrating an example platform and an example virtual meeting manager, in accordance with implementations of the present disclosure.

FIG. 3 depicts a flow diagram illustrating an example method for artificial intelligence (AI)-based document retrieval during a virtual meeting, in accordance with implementations of the present disclosure.

FIGS. 4A-4B illustrate an example of AI-based document retrieval during a virtual meeting, in accordance with implementations of the present disclosure.

FIGS. 5A-5C illustrate another example of AI-based document retrieval during a virtual meeting, in accordance with implementations of the present disclosure.

FIG. 6 illustrates an example predictive system, in accordance with implementations of the present disclosure.

FIG. 7 is a block diagram illustrating an exemplary computer system, in accordance with implementations of the present disclosure.

### DETAILED DESCRIPTION

Aspects of the present disclosure relate to artificial intelligence (AI)-based document retrieval during a virtual meeting. A platform can enable users to connect with other users through a video or audio-based virtual meeting (e.g., a conference call, etc.). The platform can provide tools that allow client devices associated with users (referred to herein as participants) to share audio data and/or video data with client devices associated with other participants (e.g., over a network). In some instances, a platform can provide or otherwise enable screen sharing, which enables a participant accessing an electronic document to share video captured from a screen image of the client device with other participants.

In some instances, a participant of a virtual meeting may decide that they want to share an electronic document with other participants during the virtual meeting. For example, based on a discussion between the participants of the virtual meeting, a participant may decide they want to share an electronic document that is relevant to the discussion. In conventional systems, the participant may withdraw from the virtual meeting discussion to search for and access the appropriate electronic document for sharing. It can take the participant a significant amount of time (e.g., minutes or longer) to identify the appropriate electronic document for sharing, if the participant identifies the appropriate electronic document at all. In some instances, other participants of the virtual meeting may pause the discussion until the participant has identified the appropriate electronic document and has initiated screen sharing. During such time when the discussion is paused, computing resources (e.g., processing cycles, network resources, memory resources, etc.) can be consumed (e.g., by the platform, by the client devices, etc.) to maintain the virtual meeting environment. Such resources are unavailable for other processes, which can increase an overall latency and decrease an overall efficiency of the system.

In other instances, the other participants of the virtual meeting may continue the discussion while the participant searches for the appropriate electronic document for screen sharing. The participant may not be aware of the state of the discussion by the time the electronic document is identified and/or screen sharing is initiated. The other participants may take additional time to summarize the points of the discussion that the participant missed while the participant was searching for the appropriate electronic document, which can extend the overall duration of the virtual meeting and can further interrupt the flow of the virtual meeting discussion. By extending the duration of the virtual meeting, additional computing resources are consumed (e.g., by the platform, by the client devices, etc.), which can further increase the overall latency and decrease the overall efficiency of the system.

Aspects of the present disclosure address the above and other deficiencies by providing AI-based document retrieval during a virtual meeting. Client devices associated with virtual meeting participants can collect multi-media streams (e.g., video signals, audio signals, textual data, etc.) provided by the participants during a virtual meeting. The multi-media streams can correspond to phrases or statements provided by the participants, in some embodiments. In some embodiments, the client devices can provide audio data including the collected audio signals and/or textual data including a transcription of the provided phrases to a platform. Such audio data and/or textual data is referred to herein as discussion data. The platform can determine whether the discussion data corresponds to an information access query by one or more participants of the virtual meeting. An information access query refers to a statement and/or a question provided by a participant corresponds to a request (or other such reference) to access information (e.g., of an electronic document) for sharing with other participants of the virtual meeting. In an illustrative example, the phrase “Can we pull up the slides from last week's meeting?” can correspond to a request to access and/or share content of a slide document that was accessed during a prior meeting between at least a portion of the participants. In another illustrative example, the phrases “I think that I saw something about that point in an article that I read the other day. We might want to use it for the slide presentation” can correspond to a request to access an article that a participant previously accessed that includes information that may be relevant for inclusion in a slide presentation document. It should be noted that the above examples are provided for the purpose of illustration only. Other types of phrases can correspond to an information access query, in accordance with embodiments of the present disclosure. Further details regarding determining whether a phrase corresponds to an information access query are described herein.

In response to determining that the discussion data corresponds to an information access query, the platform can feed the discussion data as input to an artificial intelligence (AI) model. The AI model can be trained to determine, based on given discussion data, a context of a discussion during a virtual meeting and one or more electronic documents including content that is relevant to the context of the discussion. In some embodiments, the AI model can be a large language model (LLM). Further details regarding the AI model are described herein. The platform can obtain one or more outputs of the AI model, which can indicate one or more electronic documents and, for each electronic document, a level of confidence that the electronic document is relevant to the one or more phrases included in the given discussion data. The platform can identify the electronic document having a level of confidence that satisfies one or more confidence criteria and can determine a participant of the virtual meeting that is associated with the electronic document. For example, the platform can determine the participant that is identified as a creator of the electronic document. In another example, the platform can determine the participant that provided the phrase that initiated identification of the electronic document. The platform can update a user interface (UI) of a client device associated with the participant include a notification of the identification of the electronic document. The participant can engage with one or more UI elements of the UI to access the electronic document and/or enable screen sharing of the electronic document with other participants of the virtual meeting.

As indicated above, aspects of the present disclosure cover techniques to enable a platform to identify and retrieve electronic documents relevant to a discussion of a virtual meeting. Accordingly, the platform can provide a participant associated with the electronic document with a notification of the identified electronic document, which can prevent the participant from spending time searching for and accessing the electronic document before sharing the electronic document with other participants. As the participant does not spend time searching for and accessing the electronic document, a flow of the discussion during the virtual meeting is not interrupted, and participants of the virtual meeting can be engaged in the discussion. As participants are engaged in the virtual meeting discussion, the purpose of the discussion can be realized in a more efficient manner, which can reduce the overall duration of the virtual meeting. A reduction in the overall duration of the virtual meeting can reduce the amount of computing resources consumed during the virtual meeting, which can be available for other processes (e.g., of the platform, of the client devices). Accordingly, an overall latency of the system is decreased, and an overall efficiency of the system is increased.

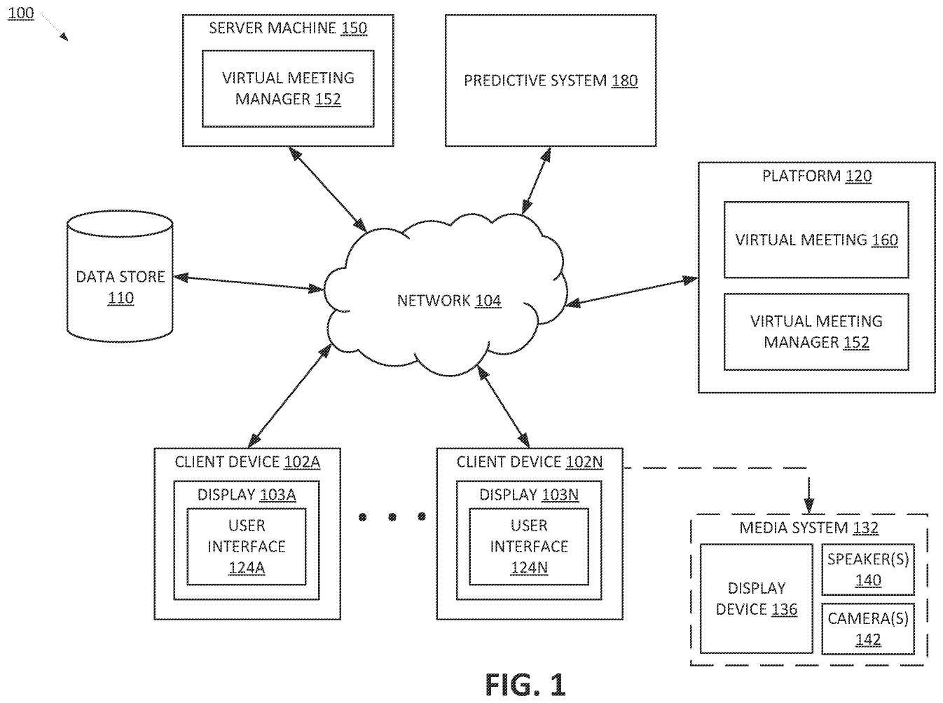

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, a server machine 150, and/or a predictive system 180 each connected to a network 104. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

Platform 120 can enable users of client devices 102A-N to connect with each other via a virtual meeting (e.g., virtual meeting 160). A virtual meeting 160 can be a video-based virtual meeting, which includes a meeting during which a client device 102 connected to platform 120 captures and transmits image data (e.g., collected by a camera of a client device 102) and/or audio data (e.g., collected by a microphone of the client device 102) to other client devices 102 connected to platform 120. The image data can, in some embodiments, depict a user or group of users that are participating in the virtual meeting 160. The audio data can include, in some embodiments, an audio recording of audio provided by the user or group of users during the virtual meeting 160. In additional or alternative embodiments, the virtual meeting 160 can be an audio-based virtual meeting, which includes a meeting during which a client device 102 captures and transmits audio data (e.g., without generating and/or transmitting image data) to other client devices 102 connected to platform 120. In some instances, a virtual meeting can include or otherwise be referred to as a conference call. In such instances, a video-based virtual meeting can include or otherwise be referred to as a video-based conference call and an audio-based virtual meeting can include or otherwise be referred to as an audio-based conference call.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” A client device 102 can include an audiovisual component that can generate audio and video data to be streamed to conference platform 120. In some implementations, the audiovisual component can include one or more devices (e.g., a microphone, etc.) that capture an audio signal representing audio provided by the user. The audiovisual component can generate audio data (e.g., an audio file or audio stream) based on the captured audio signal. In some embodiments, the audiovisual component can additionally or alternatively include one or more devices (e.g., a speaker) that output data to a user associated with a particular client device 102. In some embodiments, the audiovisual component can additionally or alternatively include an image capture device (e.g., a camera) to capture images and generate image data (e.g., a video stream) of the captured images.

In some embodiments, one or more client devices 102 can be devices of a physical conference room or a meeting room. Such client devices 102 can be included at or otherwise coupled to a media system 132 that includes one or more display devices 136, one or more speakers 140 and/or one or more cameras 142. A display device 136 can be or otherwise include a smart display or a non-smart display (e.g., a display that is not itself configured to connect to platform 120 or other components of system 100 via network 104). Users that are physically present in the conference room or the meeting room can use media system 132 rather than their own client devices 102 to participate in a virtual meeting, which may include other remote participants. For example, participants in the conference room or meeting room that participate in the virtual meeting may control display 136 to share a slide presentation with, or watch a slide presentation of, other participants that are accessing the virtual meeting remotely. Sound and/or camera control can similarly be performed. As described above, a client device 102 connected to a media system 132 can generate audio and video data to be streamed to platform 120 (e.g., using one or more microphones (not shown), speaker(s) 140 and/or camera(s) 142).

Client devices 102A-N can each include a content viewer, in some embodiments. In some implementations, a content viewer can be an application that provides a user interface (UI) (sometimes referred to as a graphical user interface (GUI)) for users to access a virtual meeting 160 hosted by platform 120. The content viewer can be included in a web browser and/or a client application (e.g., a mobile application, a desktop application, etc.). In one or more examples, a user of client device 102A can join and participate in a virtual meeting 160 via UI 124A presented via display 103A via the web browser and/or client application. A user can also present or otherwise share a document to other participants of the virtual meeting 160 via each of UIs 124A-124N. Each of UIs 124A-124N can include multiple regions that enable presentation of visual items corresponding to video streams of client devices 102A-102N provided to platform 120 during the virtual meeting 160.

In some embodiments, platform 120 can include a virtual meeting manager 152. Virtual meeting manager 152 can be configured to manage a virtual meeting 160 between two or more users of platform 120. In some embodiments, virtual meeting manager 152 can provide UI 124 to each of client devices 102 to enable users to watch and listen to each other during a video conference. Virtual meeting manager 152 can also collect and provide data associated with the virtual meeting 160 to each participant of the virtual meeting 160. Further details regarding virtual meeting manger 152 are provided herein.

As mentioned above, a user can present or otherwise share a document to other participants of the virtual meeting 160 via UI 124 of a client device 102. In some embodiments, the user may decide to share the document during the virtual meeting 160. For example, during a discussion of a virtual meeting 160, a participant may ask another participant to share a particular document. In another example, a participant may refer to an electronic document that is relevant to the conversation that may be appropriate to share with the other participants of the virtual meeting 160. Virtual meeting manager 152 can obtain discussion data including phrases uttered by participants of the virtual meeting 160 and determine whether the phrases correspond to an information access query. In response to determining that the phrases correspond to an information access query, virtual meeting manager 152 can provide the discussion data as input to an AI model that is trained to determine a context of a virtual meeting discussion based on given discussion data and identify (e.g., from data store 110) an electronic document including content that is relevant to a context of the discussion during the virtual meeting 160. Virtual meeting manager 152 can obtain one or more outputs of the AI model and can identify an electronic document including content that is relevant to the discussion based on the one or more outputs. In some embodiments, virtual meeting manager 152 can provide at least a portion of the content of the identified electronic document to participants of the virtual meeting 160 via UI 124. Further details regarding determining whether phrases correspond to an information access query and identifying an electronic document that has content relevant to the context of the virtual meeting discussion are provided herein.

It should be noted that although FIG. 1 illustrates virtual meeting manager 152 as part of platform 120, in additional or alternative embodiments, virtual meeting manager 152 can reside on one or more server machines that are remote from platform 120 (e.g., server machine 150). It should be noted that in some other implementations, the functions of platform 120, server machine 150 and/or predictive system 180 can be provided by more or a fewer number of machines. For example, in some implementations, components and/or modules of platform 120, server machine 150 and/or predictive system 180 may be integrated into a single machine, while in other implementations components and/or modules of any of platform 120, server machine 150 and/or predictive system 180 may be integrated into multiple machines. In addition, in some implementations, components and/or modules of server machine 150 and/or predictive system 180 may be integrated into platform 120.

In general, functions described in implementations as being performed platform 120, server machine 150 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing a conference call hosted by platform 120. Implementations of the disclosure are not limited to conference platforms and can be extended to any type of virtual meeting. Further implementations of the present disclosure are not limited to image data collected during a virtual meeting and can be applied to other types of image data (e.g., image data generated and provided to a content sharing platform by a client device 102).

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

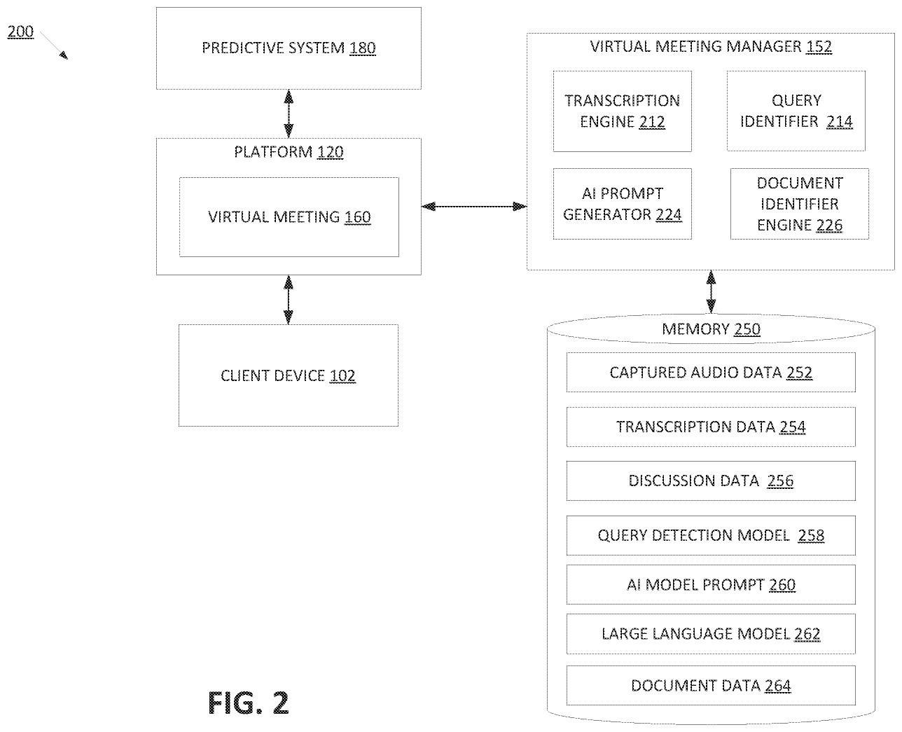

FIG. 2 is a block diagram illustrating an example platform 120 and an example virtual meeting manager 152, in accordance with implementations of the present disclosure. As described above, platform 120 can provide users (e.g., of client devices 102) with access to a virtual meeting 160. For example, one or more audiovisual components of a client device 102 (e.g., client device 102A) can generate and transmit image data and/or audio data to platform 120 during virtual meeting 160. Platform 120 can provide the received image data and/or audio data to other client devices 102 during the virtual meeting 160. Virtual meeting manager 152 can manage the virtual meeting 160 between two or more users of platform 120, as described herein.

In some embodiments, virtual meeting manager 152 can identify an electronic document that includes content that is relevant to a context of a discussion of participants of a virtual meeting 160. In some embodiments, the electronic document can include a collaborative document (e.g., a word processing document, a spreadsheet document, a slide presentation document, etc.) that is associated with at least one participant of the virtual meeting 160. In other or similar embodiments, the electronic document can include another type of document (e.g., a web page, etc.) that has been accessed by at least one participant of the virtual meeting 160. As illustrated in FIG. 2, virtual meeting manager 152 can include a transcription engine 212, a query identifier 214, an AI prompt generator 224, and/or a document identifier engine 226. Details regarding virtual meeting manager 152 and identifying a relevant electronic document are provided with respect to FIGS. 2-5C.

In some embodiments, platform 120 and/or virtual meeting manager 152 can be connected to memory 250 (e.g., via network 104, via a bus, etc.). Memory 250 can correspond to one or more regions of data store 110, in some embodiments. In other or similar embodiments, one or more portions of memory 250 can include or otherwise correspond any memory of or connected to system 100.

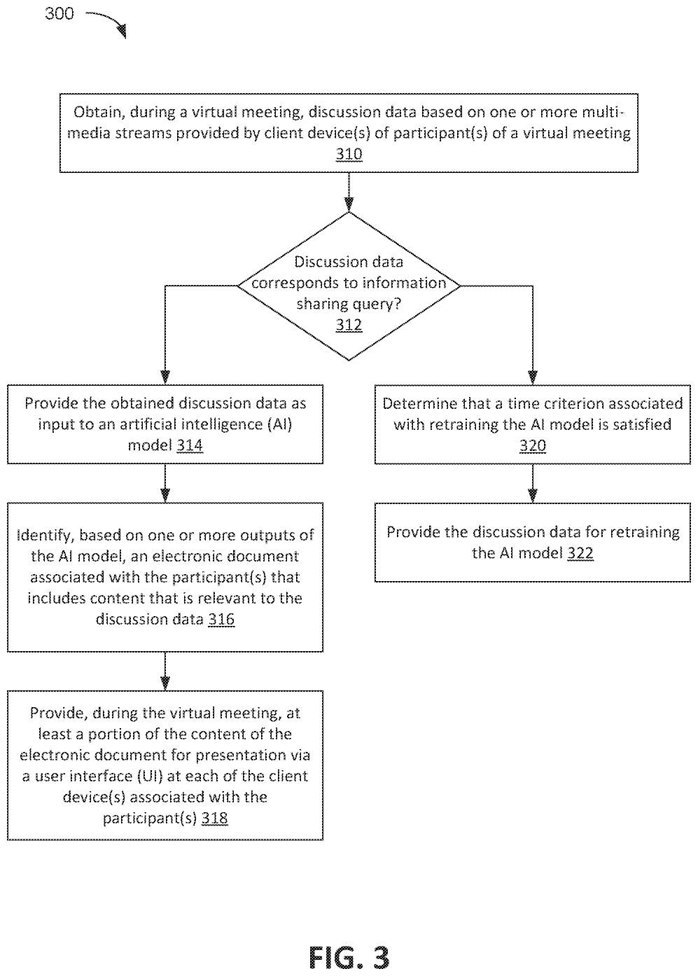

FIG. 3 depicts a flow diagram illustrating an example method 300 for AI-based document retrieval during a virtual meeting 160, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some embodiments, some or all of the operations of method 300 can be performed by virtual meeting manager 152, as described above.

At block 310, processing logic obtains discussion data based on one or more multi-media streams provided by one or more client devices of participant(s) of a virtual meeting. Processing logic can obtain the discussion data during the virtual meeting, in some embodiments. As described above, a client device 102 associated with a user (also referred to herein as a participant) of a virtual meeting 160 can capture and share audio data and/or video data with platform 120 during the virtual meeting 160. For example, a client device 102 associated with a participant can capture audio signals including one or more phrases uttered by the participant during the virtual meeting 160. Such captured audio signals are depicted as captured audio data 252 of FIG. 2. Transcription engine 212 can be configured to convert at least a portion of the audio signal into one or more text strings that include a textual representation of the one or more phrases uttered by the participant during the virtual meeting 160. Such process is referred to herein as a transcription process or simply transcription.

In some embodiments, transcription engine 212 can reside at client device 102. An audiovisual component of client device 102 can capture audio signals that include phrases uttered by the participant associated with client device 102, as described above. In some embodiments, the audiovisual component can capture the audio signals in response to detecting that the participant is uttering the one or more phrases (e.g., based on a noise detection in an environment that includes the participant). In other or similar embodiments, the audiovisual component can capture the audio signals in response to detecting that the participant has engaged with a UI element (e.g., a mute/unmute button) of UI 124 provided by platform 120. An audiovisual component of client device 102 can provide captured audio data 252 to transcription engine 212 as an input. Transcription engine 212 can convert the audio signals of captured audio data 252 to one or more text strings. The one or more text strings can be included in transcription data 254. In additional or alternative embodiments, transcription engine 212 can include additional data associated with the audio signal and/or the text strings in transcription data 254. For example, transcription data 254 can include an identifier associated with a client device 102 that collected the audio signal, a timestamp during which the audio signal was generated, etc. In some embodiments, client device 102 can provide the captured audio data 252 and/or the transcription data 254 to platform 120 (e.g., via network 104). Virtual meeting manager 152 (or another component of platform 120) can store captured audio data 252 and/or transcription data 254 at memory 250.

In other or similar embodiments, transcription engine 212 can reside at a server machine (e.g., associated with platform 120) that is remote from client device 102. In such embodiments, upon capturing the audio signals, as described above, client device 102 can provide captured audio data 252 to transcription engine 212 (e.g., via network 104). Transcription engine 212 can convert the audio signals of captured audio data 252 to one or more text strings and can include the one or more text strings with transcription data 254 (e.g., stored at memory 250). Transcription engine 212 and/or another component of virtual meeting manager 152 can store the captured audio data 252 provided by client device 102 at memory 250, as described above. It should be noted that audio signals captured by client device 102 can be converted to text string(s) according to any transcription techniques, in accordance with embodiments of the present disclosure.

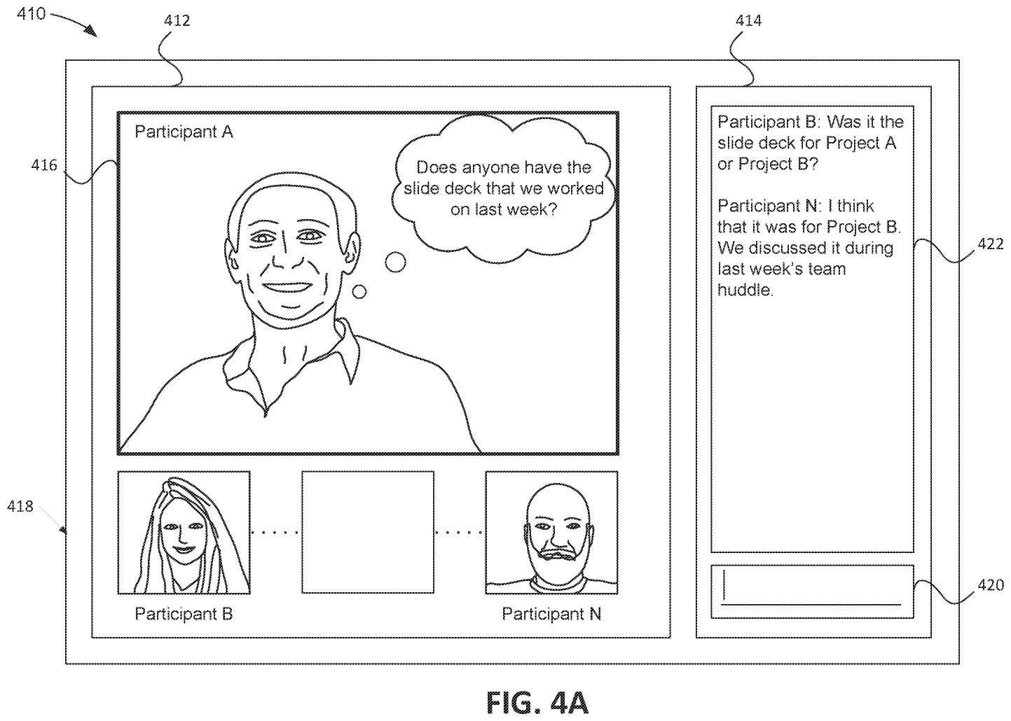

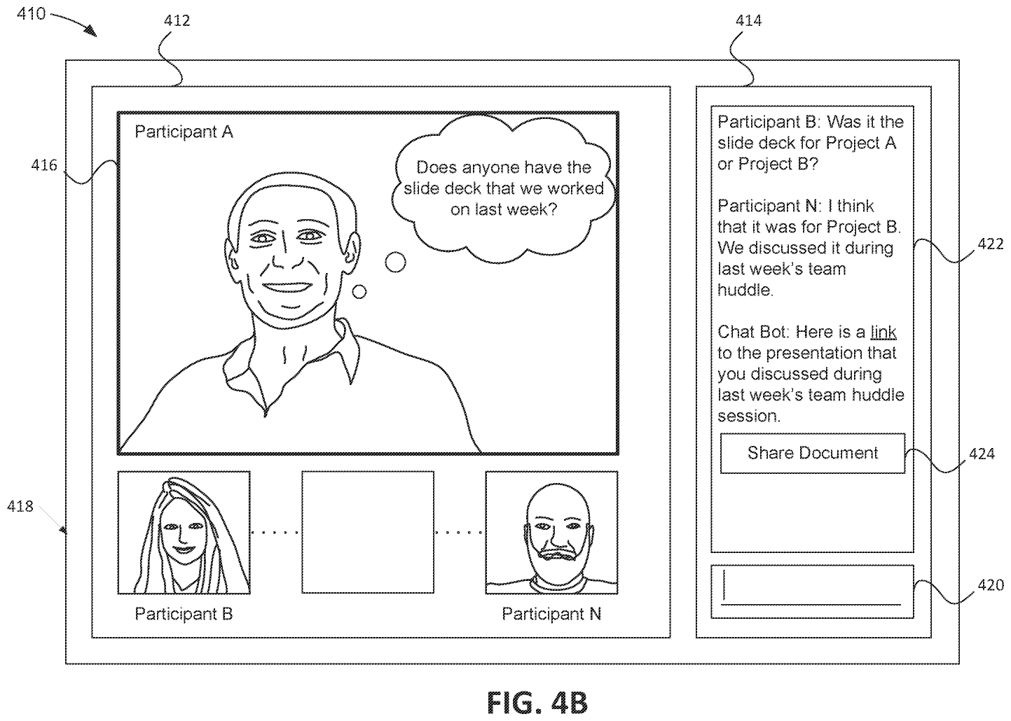

FIG. 4A illustrates a virtual meeting 160 between multiple participants via platform 120, in accordance with implementations of the present disclosure. As described above, platform 120 provides a UI 410 to enable participants (e.g., participants A-N) to join and participate in the virtual meeting 160. UI 410 is described as a UI displayed on a client device 102 associated with Participant A of virtual meeting 160. However, UI 410 can be displayed on a client device associated with any participants of virtual meeting 160.

UI 410 can include multiple sections, including a first section 412 and a second section 414. In some embodiments, the first section 412 can include one or more portions for outputting video data captured at the client devices associated with each participant. For example, the first section 412 can include at least a first portion 416 and a second portion 418 that each display video data captured by user devices associated with participants of the video conference call. In some implementations, the first portion 416 of section 412 can display video data captured by a user device associated with a participant that is providing verbal statements during the conference call (i.e., the participant that is currently speaking). In other words, the first portion 416 can display video data associated with a participant that is currently speaking. As illustrated in FIG. 4A, Participant A is providing the verbal phrase “Does anyone have the slide deck that we worked on last week?” As such, the first portion 416 of section 412 displays video data captured by a client device associated with Participant A. Second portion 418 of section 412 can display video data captured by client devices of participants (e.g., Participants B-N) that are not providing verbal statements during the conference call (i.e., are not currently speaking). In other or similar embodiments, section 412 can include one or more sections that are configured to display video data associated with participants in accordance with other orientations. For example, section 412 can include a single portion that displays the video data captured by client devices of a participant that is currently speaking and does not display video data captured by client devices of participants that are not currently speaking. In another example, section 412 can include multiple portions that each display video data associated with a participant of the video conference call, regardless of whether a participant is currently speaking.

As illustrated in FIG. 3A, Participant A can provide the verbal phrase “Does anyone have the slide deck that we worked on last week?” The audiovisual component of the client device 102 associated with Participant A can capture an audio signal based on the verbal phrase and generate audio data (e.g., an audio file) based on the captured audio signal, as described above. Transcription engine 212 (e.g., residing at client device 102 and/or at a server machine associated with platform 120) can convert the audio signal to one or more text strings, as described above.

In some embodiments, second section 414 of UI 410 can include a UI element 420 that enables participants of virtual meeting 160 to communicate with other participants via text-based messages (also referred to as chat messages). In some embodiments, a participant can engage with a peripheral device (e.g., a keyboard, a touch screen, etc.) of or otherwise connected to client device 102 to provide a chat message for presentation to other participants of the virtual meeting 160. Section 414 can additionally or alternatively include a UI element 422 that displays chat messages provided by participants of the virtual meeting. Participants can access UI elements 420 and/or 422 during the virtual meeting 160 (e.g., while other participants are talking or presenting during the virtual meeting 160). As illustrated in FIG. 4B, Participants B and N can each provide a chat message via UI element 420. For example, in response to Participant A's provided phrase of “Does anyone have the slide deck that we worked on last week?” Participant B can provide the chat message of “Was it the slide deck for Project A or Project B?” via UI element 420. Participant N can provide the chat message of “I think that it was for Project B. We discussed it during last week's team huddle,” via UI element 420. Participant A can access the chat messages provided by Participants B and N via UI element 422 in section 414 of UI 410.

As illustrated in FIG. 2, memory 250 can additionally or alternatively store discussion data 256. In some embodiments, discussion data 256 can include a mapping between an audio signal of captured audio data 252 and one or more text strings including a textual representation of phrases of the audio signal (e.g., generated by transcription engine 212). Discussion data 256 can include additional or alternative information associated with the discussion during virtual meeting. For example, discussion data can include an indication of one or more chat messages provided by participants of virtual meeting 160, as described above. In another example, discussion data 256 can include an indication of a determined context of the discussion (e.g., determined by large language model 262), as described herein. Virtual meeting manager 152 can generate discussion data 256 based on captured audio data 252, transcription data 254, and/or other data as incoming audio data 252 is received from client device(s) 102 associated with participants of the virtual meeting 160. In some embodiments, virtual meeting manager 152 can maintain separate data sets each including discussion data 256 for a respective participant of the virtual meeting 160. In other or similar embodiments, virtual meeting manager 152 can aggregate discussion data 256 into a single data set that includes discussion data 256 for all participants of the virtual meeting 160.

Referring back to FIG. 3, at block 312, processing logic determines whether at the discussion data corresponds to an information access query by the one or more participants. As described above, an information access query refers to a statement and/or a question provided by a participant that corresponds to a request (or other such reference) to access information (e.g., of an electronic document) for sharing with other participants of the virtual meeting 160. In some embodiments, an information access query can include a statement and/or a question that directly references an electronic document associated with one or more participants of the virtual meeting 160. For example, an information access query can include the phrase “Can we pull up the slides form last week's meeting?” the slides being the electronic document that is referenced by the access request. In other or similar embodiments, an information access query can include a statement or a question that passively references an electronic document associated with one or more participants of the meeting 160. For example, an information access query can include the phrase “I think that I saw something about that point in an article that I read the other day,” the article being the electronic document that is referenced by the access request. Such example phrases are provided for the purpose of example and illustration only. Any phrase referencing an electronic document, or content of an electronic document can correspond to an information access query, in accordance with embodiments of the present disclosure.

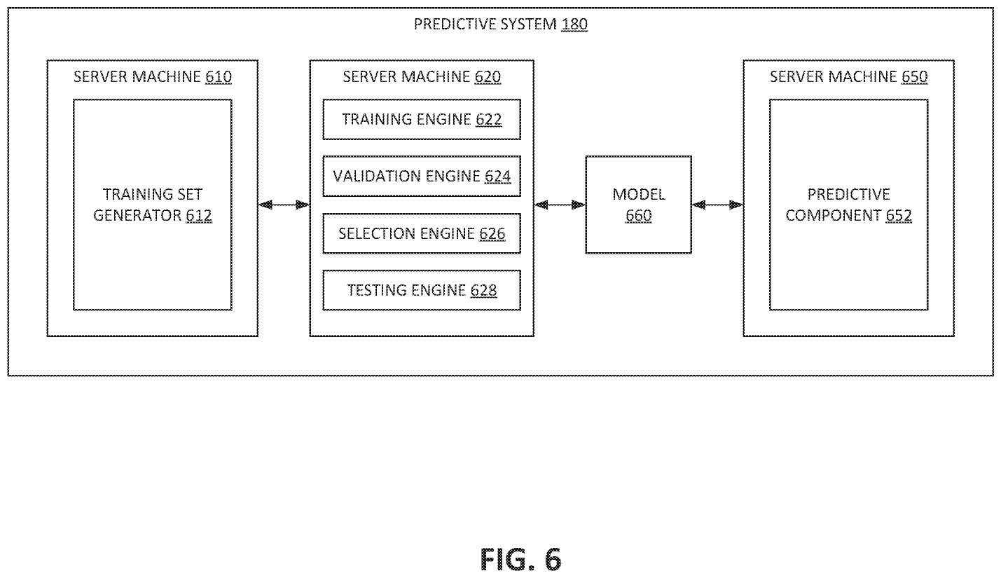

In some embodiments, query identifier 214 of virtual meeting manager 152 can determine whether phrase(s) of the discussion data correspond to an information access query based on one or more outputs of a query detection model 258. Query detection model 258 can be or otherwise include a machine learning model that is trained to predict, based on given input discussion data, whether phrases indicated by the given discussion data correspond to one or more information sharing queries by a participant of the virtual meeting 160. In some embodiments, query detection model 258 can be trained and/or reside as part of predictive system 180. Further details regarding training of query detection model 258 are provided with respect to FIG. 6.

Query identifier 214 can provide discussion data 256 as input to query detection model 258 and can obtain one or more outputs of query detection model 258, in some embodiments. The one or more outputs can include, for each respective phrase indicated by discussion data 256, a level of confidence that the respective phrase corresponds to an information access query. Query identifier 214 can determine whether any phrase indicated by discussion data 256 has a level of confidence that satisfies one or more confidence criteria to determine whether the phrase corresponds to the information access query. In some embodiments, a level of confidence for a respective phrase satisfies the confidence criteria if the level of confidence exceeds a threshold level of confidence and/or is larger than the level of confidences for other phrases of the discussion data.

In response to processing logic determining that the phrase(s) of the discussion data correspond to the information access query by the one or more participants, method 300 can proceed to block 314. In response to processing logic determining that the phrase(s) of the discussion data do not correspond to the information access query by the one or more participants, method 300 can proceed to block 320.

At block 314, processing logic provides the obtained discussion data as input to an AI model. In some embodiments, the AI model can be a large language model 262 that is trained to predict, based on given discussion data, a context (e.g., a semantic context) of a discussion of a virtual meeting 160 and identify an electronic document that includes content that is relevant phrases of the given discussion data in view of the predicted context. Further details regarding training of large language model 262 are provided with respect to FIG. 6.

In some embodiments, prompt generator 224 can generate an AI model prompt 260 based on discussion data 256 that is provided as input to large language model 262. The AI model prompt 260 can have a predefined prompt format that enables the large language model 262 to provide an accurate prediction in view of the type of request that corresponds to the AI model prompt 260. In some embodiments, prompt generator 224 can extract the information access query from at least a portion of discussion data 256. For example, as described with respect to FIG. 4A. Participant A can provide the phrase “Does anyone have the slide deck that we worked on last week?” during virtual meeting 160. Discussion data 256 can further include the phrases “Was it the slide deck for Project A or Project B?” and “I think it was for Project B. We discussed it during last week's team huddle,” as provided by Participants B and N as chat messages. Prompt generator 224 can determine, based on discussion data 256, that Participant A is looking for a slide presentation document that was accessed and/or edited during a meeting including Participant A and Participant B and/or Participant N that took place approximately a week prior to the current virtual meeting 160. Prompt generator 224 can extract such information from discussion data 256 and can generate the AI model prompt 260 based on the extracted information. The AI model prompt 260 can indicate the identified information access query (e.g., the request for the slide presentation document), the participant that provided the information access query (e.g., Participant A), and/or additional context information related to the information access query (e.g., the slide presentation document was accessed/edited during a meeting approximately a week ago).

Document identifier engine 226 can provide the AI model prompt 260 and/or discussion data 256 as input to large language model 262 and can obtain one or more outputs of the large language model 262. In some embodiments, the one or more outputs can indicate a set of electronic documents and, for each of the set of electronic documents, a level of confidence that content of the electronic documents corresponds to a context of the discussion of virtual meeting, as predicted by large language model 262.

Referring back to FIG. 3, at block 316, processing logic identifies, based on one or more outputs of the AI model, an electronic document associated with the one or more participants that comprises content that is relevant to the discussion data. Document identifier engine 226 can identify an electronic document of the set of electronic documents indicated by the output(s) of large language model 262 that have a level of confidence that satisfies one or more confidence criteria (e.g., exceed a threshold level of confidence, is larger than levels of confidence for other documents, etc.). In some embodiments, document identifier engine 226 can store an identifier associated with the identified electronic document at memory 250 as document data 264. The identifier can include an address (e.g., a web address, a memory address, etc.) associated with the identified document. In some embodiments, output(s) of large language model 262 can indicate a particular portion of content of an electronic document that is relevant to the discussion of virtual meeting 160. Document identifier engine 226 can store an indication of the region of the electronic document that includes the particular portion of content with document data, 264, in some embodiments.

At block 318, processing logic provides at least a portion of the content of the electronic document for presentation via a UI at each client device associated with one or more participants of the virtual meeting 160. In some embodiments, virtual meeting manager 152 can update a UI 124 of the client device associated with a participant associated with the identified electronic document to include a notification indicating that the electronic document was identified. For example, as illustrated in FIG. 4B, virtual meeting manager 152 can update UI 410 of client device 102 associated with Participant A to include a chat message (e.g., from “Chat Bot”) indicating that a slide presentation document shared during last week's team huddle session was identified. The notification can also include a link or a pointer to the slide presentation document. In some embodiments, section 414 can include a UI element 424 that enables Participant A to initiate sharing of the slide presentation document with other participants of virtual meeting 160. In additional or alternative embodiments, section 414 can include one or more other UI elements (not shown) that enable Participant A to preview content of the slide presentation document before initiating sharing with other participants of virtual meeting 160. In other or similar embodiments, virtual meeting manager 152 can update UI 410 to include the preview of the slide presentation document upon detection that Participant A has caused a UI element (e.g., a mouse pointer) to hover over the link or pointer to the identified electronic document.

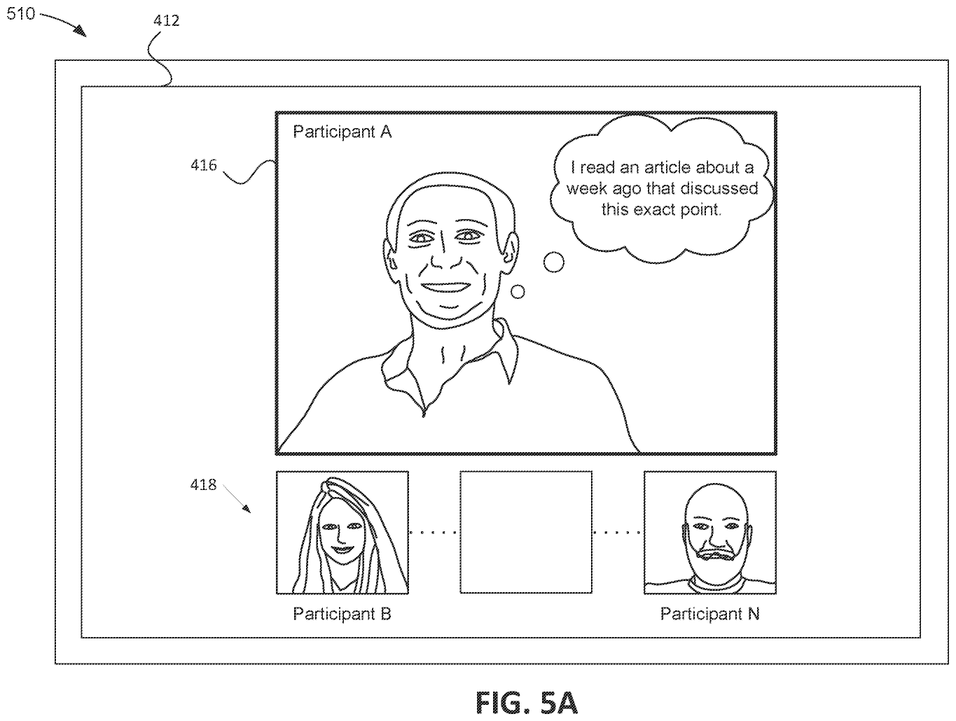

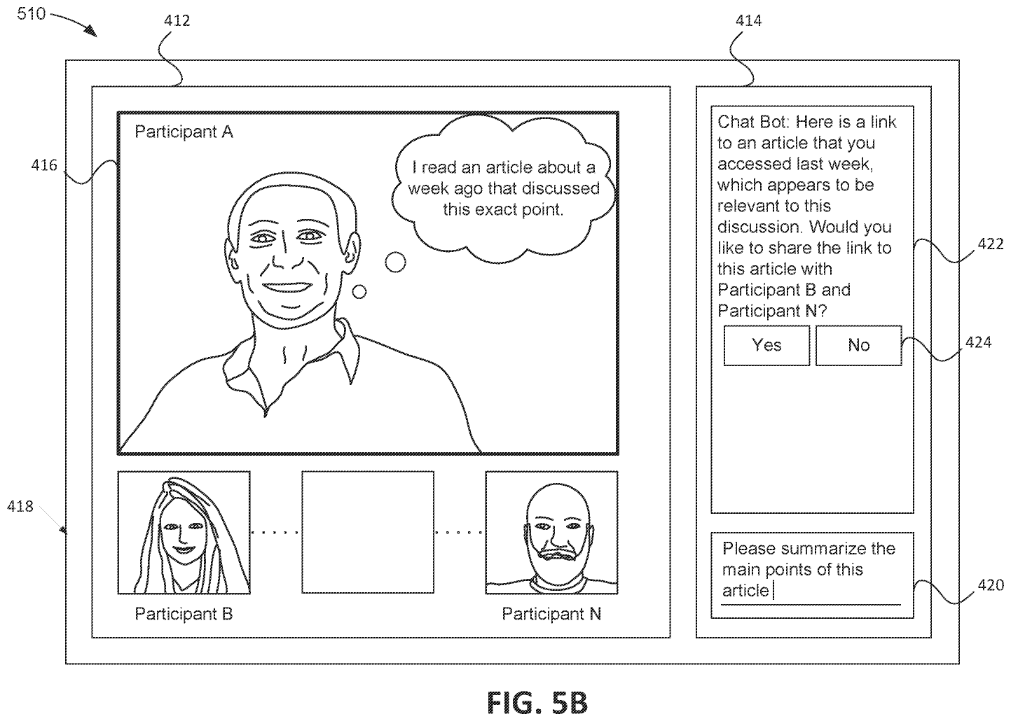

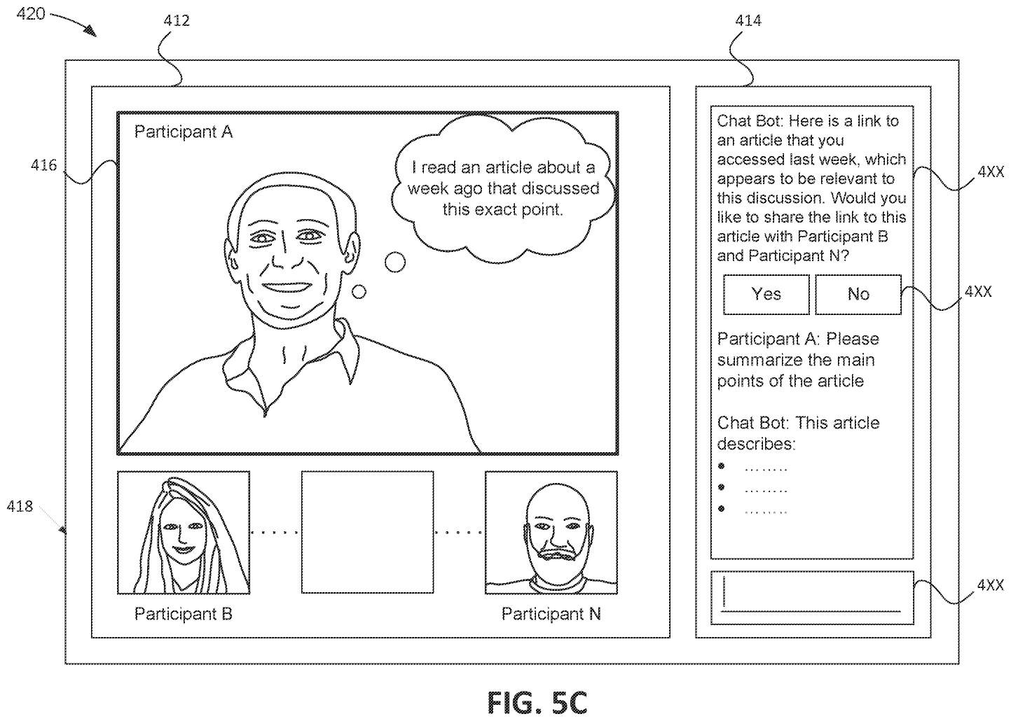

It should be noted that although embodiments the present disclosure refer to a collaborative document that is identified for sharing with participants of virtual meeting 160, any type of document can be identified for sharing with participants of virtual meeting 160. For example, FIG. 5A depicts another virtual meeting 160 between at least Participant A, Participant B, and/or Participant N. UI 510 can include similar sections as UI 410, as described above. During the virtual meeting 160, participant A can provide the phrase “I read an article about a week ago that discussed this exact point.” Transcription engine 212 can convert the audio signal captured for the provided phrase to one or more text strings, as described above, and query identifier 214 can determine that the phrase corresponds to an information access query, as described above. AI prompt generator 224 can generate an AI model prompt 260 based on discussion data 256 pertaining to the phrase provided by Participant A. For example, prompt generator 224 can determine that Participant A is looking for an article that was accessed by Participant A during a time period of approximately a week prior to the current virtual meeting 160. Prompt generator 224 can extract such information from discussion data 256 and can generate the AI model prompt 260 based on the extracted information. The AI model prompt 260 can indicate the identified information access query (e.g., the request for the article), the participant that provided the information access query (e.g., Participant A), and/or additional context information (e.g., that Participant A accessed the article about a week ago).

Document identifier engine 226 can provide the AI model prompt 260 and/or discussion data 256 as input to large language model 262 and can obtain one or more outputs, as described above. In some embodiments, document identifier engine 226 can identify a web page document pertaining to the article based on the one or more outputs of the large language model 262, as described above. If no documents indicated by the output(s) of large language model 262 satisfy the one or more confidence criteria, AI prompt generator 224 can, in some embodiments, update the additional context information of AI model prompt 260 to expand the scope of the prediction by large language model 262 (e.g., that Participant A may have accessed the article more than a week ago).

As illustrated in FIG. 5B, virtual meeting manager 152 can update section 414 of UI 510 to include a notification of the identification of the web page that includes the article referenced by Participant A during the virtual meeting 160. Section 414 can also include one or more UI elements 424 that enable Participant A to share a link to the article with the other participants of the virtual meeting.

In some embodiments, a participant can provide a request that one or more actions pertaining to the electronic document be performed by platform 120. For example, Participant A can provide a request via UI element 420 to for a summarization of the main points in the article of the web page document identified by virtual meeting manager 152. In such embodiments, virtual meeting manager 152 can provide the request as input to large language model 262 or another model that is trained to generate content. Virtual meeting manager 152 can obtain one or more outputs of model 262 (or the other model), where the one or more outputs include a summarization of the article, as requested by Participant A. As illustrated in FIG. 5C, virtual meeting manager 152 can update UI 510 to include the summarization of the points of the article, as requested by Participant A. Participant A can decide to share the article and/or the summarized points of the article with the other participants of virtual meeting 160, as described above. In other or similar embodiments, Participant A can discuss the points of the article with the participants (e.g., without sharing the points via screen sharing.

Referring back to FIG. 3, as indicated above, at block 312, processing logic determines whether at least one of the one or more phrases of the discussion data 256 correspond to an information access query by the one or more participants. In response to processing logic determining that the phrase(s) of the discussion data 256 do not correspond to the information access query by the one or more participants, method 300 can proceed to block 320. At block 320, processing logic determines that a time criterion associated with retraining the AI model is satisfied. Processing logic can determine whether the time criterion associated with retraining the AI model is satisfied by determining whether an amount of time between a prior time period during which data was given to retrain the AI model and the current time period exceeds a threshold amount of time. If the time criterion is not satisfied, processing logic can add the discussion data 256 to a region of memory 250 associated with a temporary buffer. The temporary buffer can be allocated to temporarily store discussion data that is to be provided to retrain the AI model. The temporary buffer can include additional discussion data (e.g., previously provided by participant(s) of virtual meeting 160), in accordance with previously described embodiments.

If the time criterion is satisfied, method 300 can proceed to block 322. At block 322, processing logic provides the discussion data for retraining the AI model. In some embodiments, processing logic can provide all discussion data stored at the temporary buffer for retraining the AI model. Upon providing the discussion data and/or receiving confirmation that retraining the AI model has completed, processing logic can erase or otherwise remove the discussion data stored at the temporary buffer. Incoming discussion data 256 can be stored at the temporary buffer (e.g., until the time criterion is again satisfied), as described herein.

FIG. 6 illustrates an example predictive system 180, in accordance with implementations of the present disclosure. As illustrated in FIG. 6, predictive system 180 can include a training set generator 612 (e.g., residing at server machine 610), a training engine 612, a validation engine 624, a selection 626, and/or a testing engine 628 (e.g., each residing at server machine 620), and/or a predictive component 652 (e.g., residing at server machine 650). Training set generator 612 may be capable of generating training data (e.g., a set of training inputs and a set of target outputs) to train ML model 660. Model 660 can include query detection model 258, in some embodiments. In other or similar embodiments, model 660 can include an AI model (e.g., large language model 262).

As mentioned above, training set generator 612 can generate training data for training model 660. In an illustrative example, training set generator 612 can generate training data to train query detection model 258. In such example, training set generator 612 can initialize a training set T to null (e.g., { }). Training set generator 612 can identify data corresponding to a phrase provided by a user of a platform (e.g., a user of platform 120 or another platform). In some embodiments, the phrase may be provided by the user when the user is a participant of a virtual meeting (e.g., a video-based conference call, an audio-based conference call, etc.). Training set generator 612 can determine whether the phrase corresponds to a statement associated with accessing or sharing information during a virtual meeting. In some embodiments, training set generator 612 can determine whether the phrase corresponds to an information access and/or information sharing statement based on input provided by a developer and/or engineer of predictive system 180 (e.g., via a client device 102). In other or similar embodiments, the phrase can be included in a transcript of a virtual meeting (e.g., generated after completion of the virtual meeting). Training set generator 612 can determine whether the phrase corresponds to an information access and/or information sharing statement by determining whether an electronic document (e.g., a collaborative document, a web page document, etc.) was shared with other participants of the virtual meeting in connection with the phrase. Training set generator 612 can determine whether the electronic document was shared with participants in connection with the phrase by determining whether the electronic document was accessed and/or shared within a threshold amount of time after the phrase was provided by the participant and/or whether content of the electronic document corresponds to a context of the discussion during a time period (e.g., defined by the engineer and/or developer of predictive system 180) before and/or after the phrase was provided.

Training set generator 612 can generate an input/output mapping. The input can be based on the identified data that includes the phrase and the outputs can indicate whether the phrase corresponds to a statement associated with accessing and/or sharing information during a virtual meeting (e.g., in accordance with the determination by training set generator 612). Training set generator 612 can add the input/output mapping to the training set T and can determine whether training set T is sufficient for training query detection model 258. Training set T can be sufficient for training query detection model 258 if training set T includes a threshold amount of input/output mappings, in some embodiments. In response to determining that training set T is not sufficient for training, training set generator 612 can identify additional data that indicates additional phrases provided by users of platform 120 and can generate additional input/output mappings based on the additional data. In response to determining that training set T is sufficient for training, training set generator 612 can provide training set T to train query detection model 258. In some embodiments, training set generator 612 provides the training set T to training engine 722.

As mentioned above, training set generator 612 can additionally or alternatively generate training data to train large language model 262. In some embodiments, large language model 262 can be trained to determine the context of a given input text through its ability to analyze and understand surrounding words, phrases, and patterns within the given input text. Training set generator 612 can identify or otherwise obtain sentences (or parts of sentences) of phrases provided by users of platform 120, in some embodiments. The (e.g., audio phrases, textual phrases, etc.) phrases can be provided during a virtual meeting and/or while the users access other applications provided by the platform 120 (e.g., search application, collaborative document application, content sharing application, etc.). The phrases can be included in content produced or retrieved from other sources of the Internet and/or any other database accessible by training set generator 612 and/or large language model 262. Training set generator 612 can generate an input/output mapping based on the obtained sentences (or parts of sentences). The input can include a portion of an obtained sentence of a phrase. Another portion of the obtained sentence or phrase is not included in the input. The output can include the complete sentence (or part of the sentence), which includes both the portion included in the input and the additional portion that is not included in the input. In accordance with embodiments of the present disclosure, the training set generated by training set generator 612 to train large language model 262 can include a significantly large amount of input/output mappings (e.g., millions, billions, etc.). In some embodiments, multiple input/output mappings of the training set can correspond to the same sentence (or part of the sentence), where the input of each of the input/output mappings include a different portion of the sentence (or part of the sentence).

In some embodiments, the sentences used to generate the input/output mapping of the training set can be obtained from phrases included in electronic documents (e.g., collaborative electronic documents, web page documents, etc.). In such embodiments, training set generator 612 can determine a context of one or more portions of content of an electronic document. For example, training set generator 612 can provide a portion of content as input to another machine learning model that is trained to predict a context of the content. Training set generator 612 can update an input/output mapping corresponding to the sentence included in the electronic document to include the determined context. In other or similar embodiments, training set generator 612 can update the input/output mapping for the sentence to include an indicator of the electronic document (e.g., a pointer or link to the document, a memory address or a web address for the electronic document).

Training engine 622 can train a machine learning model 660 using the training data (e.g., training set T) from training set generator 612. The machine learning model 660 (e.g., query detection model 258, large language model 262, etc.) can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the machine learning model 660 that captures these patterns. The machine learning model 660 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. For convenience, the remainder of this disclosure will refer to the implementation as a neural network, even though some implementations might employ an SVM or other type of learning machine instead of, or in addition to, a neural network. In one aspect, the training set is obtained by training set generator 612 hosted by server machine 610.

Validation engine 624 may be capable of validating a trained machine learning model 660 using a corresponding set of features of a validation set from training set generator 612. The validation engine 624 may determine an accuracy of each of the trained machine learning models 660 based on the corresponding sets of features of the validation set. The validation engine 624 may discard a trained machine learning model 660 that has an accuracy that does not meet a threshold accuracy. In some embodiments, the selection engine 626 may be capable of selecting a trained machine learning model 660 that has an accuracy that meets a threshold accuracy. In some embodiments, the selection engine 626 may be capable of selecting the trained machine learning model 660 that has the highest accuracy of the trained machine learning models 660.

The testing engine 186 may be capable of testing a trained machine learning model 660 using a corresponding set of features of a testing set from training set generator 612. For example, a first trained machine learning model 660 that was trained using a first set of features of the training set may be tested using the first set of features of the testing set. The testing engine 628 may determine a trained machine learning model 660 that has the highest accuracy of all of the trained machine learning models based on the testing sets.

As described above, predictive system 180 can be configured to train a large language model 262. It should be noted that predictive system 180 can train the large language model 262 in accordance with embodiments described herein and/or in accordance with other techniques for training a large language model. For example, large language model 262 may be trained on a large amount of data, including prediction of one or more missing words in a sentence, identification of whether two consecutive sentences are logically related to each other, generation of next texts based on prompts, etc.

Predictive component 652 of server machine 750 may be configured to feed data as input to model 660 and obtain one or more outputs. As described above, model 660 can correspond to query detection model 258, in some embodiments. In such embodiments, predictive component 652 (e.g., residing at or otherwise connected to query identifier 214 of virtual meeting manager 152) can feed discussion data 256 as input to query detection model 258 and obtain one or more outputs, which indicate whether a phrase of discussion data 256 corresponds to an information access phrase, as described above.

As indicated above, in some embodiments, model 660 can be a large language model 262. In some embodiments, large language model 262 can include generative AI functionality. In such embodiments, model 262 can generate new content based on provided input data (e.g., discussion data 256). The generative machine learning model 262 can be supported by an AI server (not shown), in some embodiments. In some embodiments, the AI server can provide a query tool, which enables one or more users of platform 120 to access the generative machine learning model. The query tool can include or otherwise interface with a prompt interface described above). The query tool can be configured to perform automated identification and facilitate retrieval of relevant and timely contextual information for quick and accurate processing of user queries by model 262. Via network 104 (or another network), the query tool may be in communication with one or more client devices 102, the AI server, data store 110, memory 250, and/or platform 120. Communications between the query tool and the AI server may be facilitated by a generative model application programming interface (API), in some embodiments. Communications between the query tool and data store 110 and/or memory 250 via a data management API, in some embodiments. In additional or alternative embodiments, the generative model API can translate queries generated by the query tool into unstructured natural-language format and, conversely, translate responses received from model 262 into any suitable form (e.g., including any structured proprietary format as may be used by the query tool). Similarly, the data management API can support instructions that may be used to communicate data requests to data store 110 and/or memory 250 and formats of data received from data store 110 and/or memory 250.

As indicated above, a user can interact with the query tool via the prompt interface. The prompt interface be or otherwise include a UI element that can support any suitable types of user inputs (e.g., textual inputs, speech inputs, image inputs, etc.). The UI element may further support any suitable types of outputs (e.g., textual outputs, speech outputs, image outputs, etc.). In some embodiments, the UI element can be a web-based UI element, a mobile application-supported UI element, or any combination thereof. The UI element can include selectable items, in some embodiments, that enables a user to select from multiple generative models 262. The UI element can allow the user to provide consent for the query tool and/or generative model 262 to access user data or other data associated with a client device 102 stored in data store 110 and/or memory 250, process, and/or store new data received from the user, and the like. The UI element can additionally or alternatively allow the user to withhold consent to provide access to user data to the query tool and/or generative model 262. In some embodiments, a user input entered via the UI element may be communicated to the query tool via a user API. The user API can be located at the client device 102 of the user accessing the query tool.

In some embodiments, the query tool can include a user query analyzer to support various operations of this disclosure. For example, the user query analyzer may receive a user input, e.g., user query, and generate one or more intermediate queries to generative model 260 to determine what type of user data the generative model 260 might need to successfully respond to user input. Upon receiving a response from generative model 262, the user query analyzer may analyze the response, form a request for relevant contextual data for data store 110 and/or memory 250, which may then supply such data. The user query analyzer may then generate a final query to generative model 262 that includes the original user query and the contextual data received from data store 110 and/or memory 250. In some embodiments, the user query analyzer may itself include a lightweight generative model that may process the intermediate query (ies) and determine what type of contextual data may have to be provided to generative model 262 together with the original user query to ensure a meaningful response from generative model 262.

The query tool may include (or may have access to) instructions stored on one or more tangible, machine-readable storage media of a server machine (e.g., server machine 650) and executable by one or more processing devices of server machine 650. In one embodiment, the query tool may be implemented on a single machine. In some embodiments, the query tool may be a combination of a client component and a server component. In some embodiments the query tool may be executed entirely on the client device(s) 102. Alternatively, some portion of the query tool may be executed on a client computing device while another portion of the query tool may be executed on a server machine.

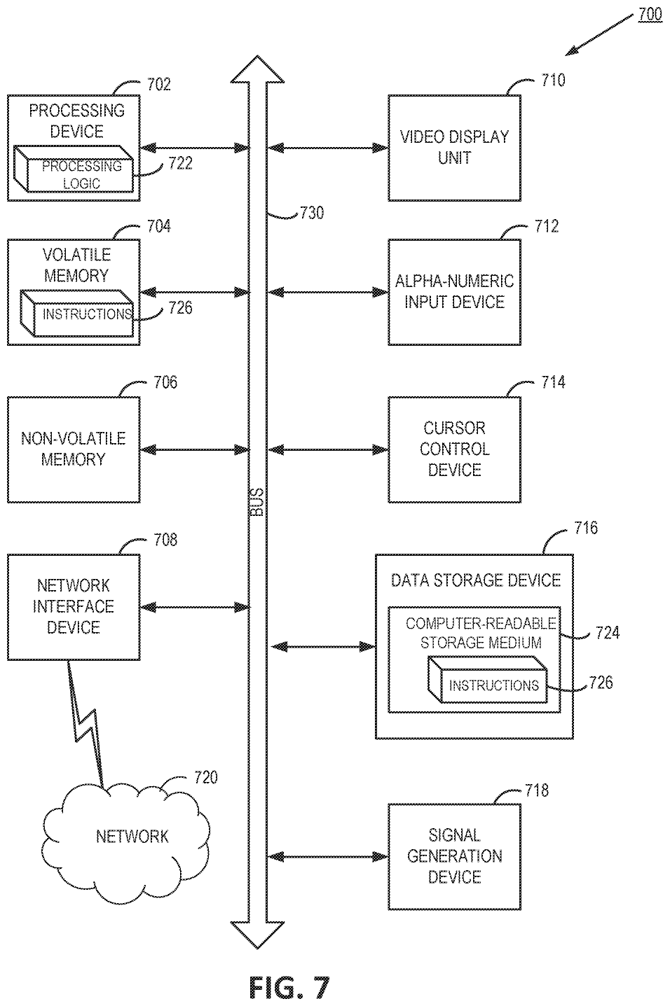

FIG. 7 is a block diagram illustrating an exemplary computer system 700, in accordance with implementations of the present disclosure. The computer system 700 can correspond to platform 120 and/or client devices 102A-N, described with respect to FIG. 1. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 (e.g., improving precision of content matching systems at a platform) for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 (e.g., improving precision of content matching systems at a platform) embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
providing a user interface (UI) for a virtual meeting to client devices of a plurality of participants of the virtual meeting;
obtaining, during the virtual meeting, discussion data based on one or more multi-media streams provided by one or more client devices of one or more participants of the plurality of participants of the virtual meeting;
determining, during the virtual meeting, whether the discussion data corresponds to an information access query by the one or more participants;
responsive to determining that the discussion data corresponds to the information access query, providing, during the virtual meeting, the discussion data as input to an artificial intelligence (AI) model, wherein the AI model is trained to identify, from a data store comprising electronic documents associated with users of a platform, one or more electronic documents that comprise content that is relevant to given discussion data;
identifying, during the virtual meeting and based on one or more outputs of the AI model, an electronic document associated with at least one of the plurality of participants that comprises content that is relevant to the discussion data; and
updating, during the virtual meeting, the UI at each of the one or more client devices to include at least a portion of the content of the electronic document.

2. The method of claim 1, further comprising:
responsive to determining that the discussion data does not correspond to the information access query, determining that a time criterion associated with retraining the AI model is satisfied; and
providing the discussion data for retraining the AI model.

3. The method of claim 2, wherein determining that the time criterion associated with retraining the AI model is satisfied comprises:
determining that an amount of time between a prior time period during which data was given to retrain the AI model and a current time period exceeds a threshold amount of time.

4. The method of claim 1, further comprising:
extracting the information access query from the discussion data;
generating an AI model prompt based on the extracted information access query and an identifier associated with the one or more participants associated with the discussion data, wherein the AI model prompt has a predefined prompt format; and
providing the generated AI model prompt as input to the AI model.

5. The method of claim 1, wherein determining whether the discussion data corresponds to the information access query by the one or more participants comprises:
providing the discussion data as input to an additional AI model, wherein the additional AI model is trained to predict, based on given input discussion data, whether phrases indicated by the given discussion data correspond to one or more information sharing queries by a participant of the virtual meeting;
obtaining one or more outputs of the additional AI model, wherein the one or more outputs comprise a level of confidence that the discussion data corresponds to the information access query; and
determining whether the level of confidence satisfies a level of confidence criterion.

6. The method of claim 1, wherein the discussion data comprises at least one of audio data comprising one or more audio signals collected by the one or more client devices or transcription data comprising a textual transcription of the one or more audio signals.

7. The method of claim 1, wherein the AI model is a large language model.

8. A system comprising:
a memory device; and
a processing device coupled to the memory device, the processing device to perform operations comprising:
providing a user interface (UI) for a virtual meeting to client devices of a plurality of participants of the virtual meeting;
obtaining, during the virtual meeting, discussion data based on one or more multi-media streams provided by one or more client devices of one or more participants of the plurality of participants of the virtual meeting;
determining, during the virtual meeting, whether the discussion data correspond to an information access query by the one or more participants;
responsive to determining that the discussion data correspond to the information access query, providing, during the virtual meeting, the discussion data as input to an artificial intelligence (AI) model, wherein the AI model is trained to identify, from a data store comprising electronic documents associated with users of a platform, one or more electronic documents that comprise content that is relevant to given discussion data;
identifying, during the virtual meeting and based on one or more outputs of the AI model, an electronic document associated with at least one of the plurality of participants that comprises content that is relevant to the discussion data; and
updating, during the virtual meeting, the UI at each of the one or more client devices to include at least a portion of the content of the electronic document.

9. The system of claim 8, wherein the operations further comprise:
responsive to determining that the discussion data does not correspond to the information access query, determining that a time criterion associated with retraining the AI model is satisfied; and
providing the discussion data for retraining the AI model.

10. The system of claim 9, wherein determining that the time criterion associated with retraining the AI model is satisfied comprises:
determining that an amount of time between a prior time period during which data was given to retrain the AI model and a current time period exceeds a threshold amount of time.

11. The system of claim 8, wherein the operations further comprise:
extracting the information access query from the discussion data;
generating an AI model prompt based on the extracted information access query and an identifier associated with the one or more participants associated with the discussion data, wherein the AI model prompt has a predefined prompt format; and
providing the generated AI model prompt as input to the AI model.

12. The system of claim 8, wherein determining whether the discussion data corresponds to the information access query by the one or more participants comprises:
providing the discussion data as input to an additional AI model, wherein the additional AI model is trained to predict, based on given input discussion data, whether phrases indicated by the given discussion data correspond to one or more information sharing queries by a participant of the virtual meeting;
obtaining one or more outputs of the additional AI model, wherein the one or more outputs comprises a level of confidence that the discussion data corresponds to the information access query; and
determining whether the level of confidence for satisfies a level of confidence criterion.

13. The system of claim 8, wherein the discussion data comprises at least one of audio data comprising one or more audio signals collected by the one or more client devices or transcription data comprising a textual transcription of the one or more audio signals.

14. A non-transitory computer readable storage medium comprising instructions for a server that, when executed by a processing device, cause the processing device to perform operations comprising:
providing a user interface (UI) for a virtual meeting to client devices of a plurality of participants of the virtual meeting;
obtaining, during the virtual meeting, discussion data based on one or more multi-media streams provided by one or more client devices of one or more participants of the plurality of participants of the virtual meeting;
determining, during the virtual meeting, whether the discussion data correspond to an information access query by the one or more participants;
responsive to determining that the discussion data correspond to the information access query, providing, during the virtual meeting, the discussion data as input to an artificial intelligence (AI) model, wherein the AI model is trained to identify, from a data store comprising electronic documents associated with users of a platform, one or more electronic documents that comprise content that is relevant to given discussion data;
identifying, during the virtual meeting and based on one or more outputs of the AI model, an electronic document associated with at least one of the plurality of participants that comprises content that is relevant to the discussion data; and
updating, during the virtual meeting, the UI at each of the one or more client devices to include at least a portion of the content of the electronic document.

15. The non-transitory computer readable storage medium of claim 14, wherein the operations further comprise:
responsive to determining that the discussion data do not correspond to the information access query, determining that a time criterion associated with retraining the AI model is satisfied; and
providing the discussion data for retraining the AI model.

16. The non-transitory computer readable storage medium of claim 15, wherein determining that the time criterion associated with retraining the AI model is satisfied comprises:
determining that an amount of time between a prior time period during which data was given to retrain the AI model and a current time period exceeds a threshold amount of time.

17. The non-transitory computer readable storage medium of claim 14, wherein the operations further comprise:
extracting the information access query from the discussion data;
generating an AI model prompt based on the extracted information access query and an identifier associated with the one or more participants associated with the discussion data, wherein the AI model prompt has a predefined prompt format; and
providing the generated AI model prompt as input to the AI model.

18. The non-transitory computer readable storage medium of claim 14, wherein determining whether the discussion data corresponds to the information access query by the one or more participants comprises:
providing the discussion data as input to an additional AI model, wherein the additional AI model is trained to predict, based on given input discussion data, whether phrases indicated by the given discussion data correspond to one or more information sharing queries by a participant of the virtual meeting;
obtaining one or more outputs of the additional AI model, wherein the one or more outputs comprises a level of confidence that the discussion data corresponds to the information access query; and
determining whether the level of confidence satisfies a level of confidence criterion.

19. The non-transitory computer readable storage medium of claim 14, wherein the discussion data comprises at least one of audio data comprising one or more audio signals collected by the one or more client devices or transcription data comprising a textual transcription of the one or more audio signals.

20. The non-transitory computer readable storage medium of claim 14, wherein the AI model is a large language model.
